(19) United States
(12) Patent Application Publication
(10) Pub. No.: US 2017/0298998 A1
(43) Pub. Date: Oct. 19, 2017

(54) ENGAGEMENT DEVICE

(71) Applicant: TOYOTA JIDOSHA KABUSHIKI KAISHA, Toyota-shi (JP)

(72) Inventors: Takaho KAWAKAMI, Susono-shi (JP); Hirotsugu YOSHINO, Susono-shi (JP)

(73) Assignee: TOYOTA JIDOSHA KABUSHIKI KAISHA, Toyota-shi (JP)

(21) Appl. No.: 15/487,933

(22) Filed: Apr. 14, 2017

(30) Foreign Application Priority Data
Apr. 18, 2016 (JP) 2016-083228

(51) Int. Cl. F16D 25/04; F15B 15/10; F15B 15/24; F16D 13/52

(52) U.S. Cl. CPC F16D 25/048; F15B 15/24; F15B 15/10; F16D 13/52

(57) ABSTRACT

In an engagement device provided with a hydraulic actuator having an oil bag expanding and contracting in an engaging direction and a releasing direction, an annular engagement plate moved by the oil bag in the engaging direction and the releasing direction, and a return mechanism that urges the engagement plate in the releasing direction, the engagement plate is an engagement element whose surface on the releasing direction side is in contact with the oil bag, and the return mechanism moves the engagement plate in the releasing direction and presses the oil bag through the engagement plate.

### INCORPORATION BY REFERENCE

The disclosure of Japanese Patent Application No. 2016-083228 filed on Apr. 18, 2016 including the specification, drawings and abstract is incorporated herein by reference in its entirety.

### BACKGROUND

### 1. Technical Field

The disclosure relates to an engagement device.

### 2. Description of Related Art

Japanese Patent Application Publication No. 59-144803 (JP 59-144803 A) discloses a fluid pressure actuator as an engagement device of an epicyclic gear mechanism. In the fluid pressure actuator, a tube made of flexible membrane is provided in a bottom part of a cylinder. In the engagement device described in JP 59-144803 A, once pressurized hydraulic fluid is supplied into the tube, the hydraulic fluid presses a piston through the tube and moves the piston in an engaging direction.

### SUMMARY

However, in the engagement device described in JP 59-144803 A, when the tube made of flexible membrane becomes difficult to bend due to deterioration with time, the tube does not return to its initial shape even when the hydraulic fluid is discharged. Therefore, engagement elements stay in contact, making it hard for the engagement elements to be released sufficiently.

The disclosure provides an engagement device that is able to make sure that an engagement element operated by a fluid pressure actuator is released.

An example aspect of the present disclosure includes an engagement device. The engagement device includes a fluid pressure actuator provided with an expandable container, the expandable container configured to i) expand in an engaging direction by fluid supplied into the expandable container, ii) contract in a releasing direction by the fluid discharged from inside of the expandable container, an engagement plate being an annular engagement plate, the engagement plate configured to be moved to the engaging direction and the releasing direction by the expandable container, a surface of the engagement plate located on the releasing direction side being an engagement element that is to be contact with the expandable container, and a return mechanism configured to urge the engagement plate in the releasing direction, the return mechanism being configured to move the engagement plate to the releasing direction, the return mechanism being configured to press the expandable container via the engagement plate. An example aspect of the present disclosure includes an engagement device. The engagement device includes a first plate being an annular engagement plate, a second plate being an annular engagement plate, a fluid pressure actuator provided with an expandable container, the expandable container configured to i) expand by fluid supplied into the expandable container such that the first plate and the second plate engage each other, ii) contract by the fluid discharged from inside of the expandable container such that the first plate and the second plate are released each other, iii) contact with a surface of the first plate opposite to a surface that contacts with the second plate, and a return mechanism configured to urge the first plate such that the return mechanism presses the expandable container via the first plate thereby the first plate and the second plate are released each other.

According to the disclosure, when the fluid is discharged from inside of the elastic container, the return mechanism moves the engagement plate in the releasing direction and also forcefully compresses the elastic container. Thus, the engagement device is able to ensure that the engagement element is released.

The engagement device may further include a stopper configured to restrict a movement of the engagement plate in the releasing direction at a given position. The expandable container may be provided between a case that houses a transmission and the engagement plate, when the fluid is discharged from inside of the expandable container, the stopper may be configured to bring the engagement plate and the case into contact with each other, and the engagement plate may stop at the given position.

In the above-mentioned disclosure, the return mechanism and the stopper structure are able to return the engagement plate to the given position when released. As a result, drag torque generated during the release is stabilized, thereby reducing vibration and noise such as rattling.

The case may include a spline recessed part that is spline-fitted to an outer circumferential part of the engagement plate, the spline recessed part may be provided with a projecting part as the stopper, and the engagement plate may be configured to stop at the given position as the outer circumferential part of the engagement plate comes into contact with the projecting part.

In the above-mentioned disclosure, the return mechanism and the stopper structure are able to return the engagement plate to the given position when released. As a result, drag torque generated during the release is stabilized, thereby reducing vibration and noise such as rattling.

The outer circumferential part of the engagement plate may be provided with a spline projecting part that is spline-fitted to the case, the spline projecting part may be provided with a projecting part projecting in the releasing direction, and the engagement plate may be configured to stop at the given position when the projecting part serving as the stopper comes into contact with the case.

In the above-mentioned disclosure, the return mechanism and the stopper structure are able to ensure that the engagement plate is returned to the given position when released. As a result, drag torque generated during the release is stabilized, thereby reducing vibration and noise such as rattling.

According to the disclosure, when the fluid is discharged from inside of the elastic container, the return mechanism is able to move the engagement plate in the releasing direction and to forcefully compress the elastic container. Thus, it is ensured that the engagement device releases the engagement element.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view of a state where an engagement device according to the first embodiment is released;

FIG. 2 is a sectional view of a state where the engagement device according to the first embodiment is engaged;

FIG. 3 is a schematic view of an overall shape of an oil bag included in a hydraulic actuator;

FIG. 4 is a sectional view explaining a modification of the first embodiment;

FIG. 5 is a view schematically showing gear engagement elements;

FIG. 6 is a sectional view explaining an engagement device according to the second embodiment;

FIG. 7 is a sectional view explaining a modification of the second embodiment;

FIG. 8A is a schematic view of a spline-fitted state, and FIG. 8B is a schematic view explaining a stopper structure;

FIG. 9 is a view explaining an arrangement of an oil bag in a modification; and

FIG. 10 is a view explaining a modification of the oil bag.

### DETAILED DESCRIPTION OF EMBODIMENTS

An engagement device according to embodiments of the disclosure is explained below with reference to the drawings.

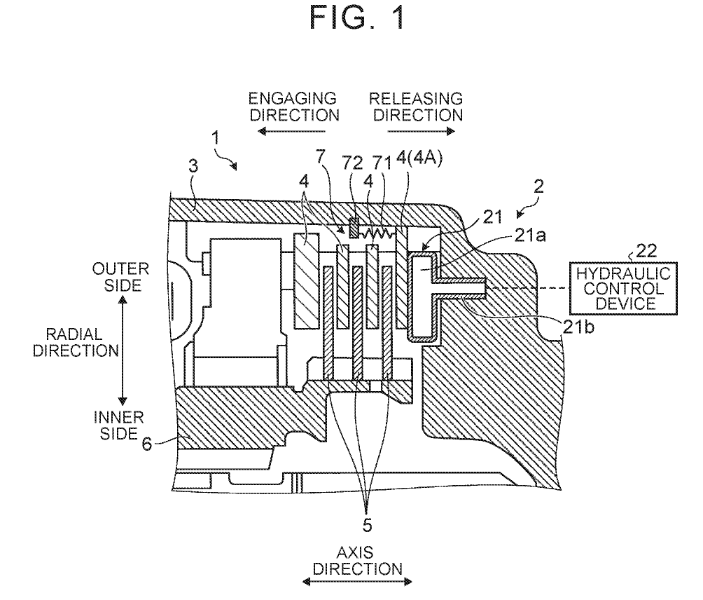

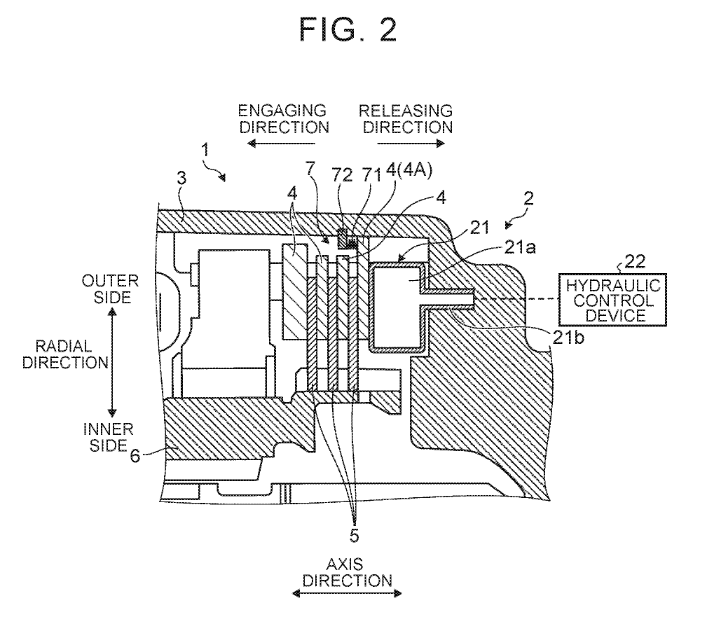

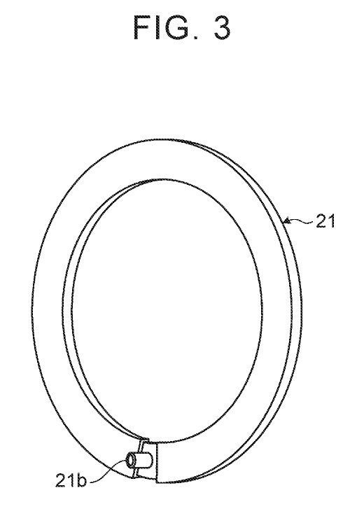

An engagement device according to the first embodiment is explained with reference FIG. 1 to FIG. 3. FIG. 1 is a sectional view of a state where the engagement device according to the first embodiment is released. FIG. 2 is a sectional view of a state where the engagement device according to the first embodiment is engaged. FIG. 3 is a schematic view of the overall shape of an oil bag included in a hydraulic actuator.

As shown in FIG. 1 and FIG. 2, an engagement device 1 according to the first embodiment is made of a friction-type multiplate clutch, and is engaged and released by a hydraulic actuator 2. The engagement device 1 is mounted on a vehicle, functions as a transmission clutch, and is provided inside a case 3 in which a transmission is housed.

The engagement device 1 includes first plates 4, which serve as fixed-side engagement elements, and second plates 5, which serve as rotation-side engagement elements. The first plate 4 is made of an annular clutch plate, and its outer circumferential part (a radially outer part) is spline-fitted to the case 3 and fixed so as not to rotate. The second plate 5 is made of an annular clutch plate (a clutch disc), and its inner circumferential part (a radially inner part) is spline-fitted to a rotating member 6 of the transmission so as to rotate. The rotating member 6 is made of a clutch hub, which rotates integrally with a rotating shaft of the transmission, and a member that rotates integrally with a rotating element of an epicyclic gear mechanism included in the transmission. The number of plates 4, 5 provided is more than one, and the plates 4, 5 are arranged alternately in the axis direction of the transmission.

Among the first plate 4, the engagement plate 4A arranged on the most releasing direction side (a position close to the oil bag 21) is an engagement element in contact with the oil bag 21. A surface of the engagement plate 4A on the releasing direction side faces the oil bag 21 of the hydraulic actuator 2, and is a surface on which hydraulic pressure (fluid pressure) inside the oil bag 21 acts directly from the oil bag 21. Meanwhile, a surface of the engagement plate 4A on the engagement side faces the second plate 5, and is a surface that is frictionally engaged with the second plate 5 (a frictional engagement surface).

The hydraulic actuator 2 is a fluid pressure actuator that has the oil bag 21 made from an elastic member having elasticity, such as rubber, and allows the plates 4, 5 to be engaged with and released from each other based on volumetric changes of the oil bag 21 and pressure changes inside a hydraulic chamber 21a. The oil bag 21 is a container (an elastic container) that expands and contracts in the engaging direction and the releasing direction with its volumetric changes made by oil. In the hydraulic actuator 2, a hydraulic control device 22 controls supply and discharge of hydraulic pressure (oil) to/from the hydraulic chamber 21a inside the oil bag 21. The hydraulic control device 22 includes a hydraulic circuit having an oil pump (not shown) serving as a supply source of hydraulic pressure, and supplies oil, whose pressure is regulated by the hydraulic circuit, to the hydraulic chamber 21a. This means that hydraulic pressure inside the hydraulic chamber 21a is regulated by the hydraulic control device 22.

To be more specific, the oil bag 21 is made of a bag-like structure having a quadrangular sectional shape, and inside of the oil bag 21 serves as the hydraulic chamber 21a in a liquid-tight state. As shown in FIG. 3, the oil bag 21 is made of an annular tube. A connection port 21b provided in the oil bag 21 functions as a supply port and a discharge port of oil. As shown in FIG. 1, as the connection port 21b is attached to the case 3, the hydraulic chamber 21a of the oil bag 21 is connected with the hydraulic control device 22 so that oil is able to pass. Then, as shown in FIG. 2, the oil bag 21 expands in the engaging direction as oil (hydraulic pressure) is supplied into the hydraulic chamber 21a, and, as shown in FIG. 1, as oil is discharged from the hydraulic chamber 21a (hydraulic pressure is decreased), the oil bag 21 contracts in the releasing direction. When oil is discharged from the hydraulic chamber 21a, the oil bag 21 contracts due to its own elastic force and tries to return to its initial shape. The initial shape means a shape of the oil bag 21 contracting to a given position in the releasing direction in a state where hydraulic pressure of the hydraulic chamber 21a is decreased so that the oil bag 21 does not press the engagement plate 4A.

The engagement device 1 also includes a return mechanism 7 that moves the engagement plate 4A in the releasing direction and compresses the oil bag 21 in the releasing direction. As shown in FIG. 1, the return mechanism 7 has a return spring 71 and a snap ring 72 arranged on the other side of the oil bag 21 across the engagement plate 4A, and urges the engagement plate 4A in the releasing direction. This means that, the return mechanism 7 causes urging force of the return spring 71 to act on the engagement plate 4A and the oil bag 21 as a load in the releasing direction.

In the example shown in FIG. 1, in a part where the engagement plate 4A and the case 3 are spline-fitted to each other, the snap ring 72 is attached to a spline recessed part of the case 3, and, one end of the return spring 71 is in contact with a surface of the engagement plate 4A in the engaging direction (a spline projecting part). This means that the return spring 71 is made of an elastic member that is provided between the snap ring 72 and the engagement plate 4A and presses the engagement plate 4A in the releasing direction. For example, the return spring 71 is made of a plurality of coil springs or wave springs. In the engagement device 1, since urging force of the return spring 71 (a load in the releasing direction) acts on the oil bag 21 through the engagement plate 4A, the return mechanism 7 makes it possible to compress the oil bag 21 in the releasing direction. In this case, the return mechanism 7 presses the oil bag 21 in the releasing direction through the engagement plate 4A. Also, the engagement device 1 is structured so that the hydraulic actuator 2 moves the engagement plate 4A in the engaging direction and the releasing direction.

When engaging the engagement device 1, by supplying hydraulic pressure (oil) into the hydraulic chamber 21a, a state changes from the released state shown in FIG. 1 to the engaged state shown in FIG. 2. During the engagement operation, the oil bag 21 expands in the engaging direction, and pressing force (a load in the engaging direction based on hydraulic pressure) acting on the engagement plate 4A from the oil bag 21 increases. Therefore, the engagement plate 4A moves in the engaging direction against the urging force of the return spring 71. Then, a surface of the engagement plate 4A on the engagement side (a frictional engagement surface) is in contact with the frictional engagement surface of the second plate 5, and the first plates 4 (including the engagement plate 4A) and the second plates 5 are frictionally engaged with each other. Thus, the engagement device 1 is changed into the engaged state. In the engaged state, the hydraulic control device 22 controls hydraulic pressure inside the oil bag 21 to be given pressure.

When the engagement device 1 is released, because oil is discharged from the hydraulic chamber 21a (hydraulic pressure is decreased), the state is changed from the engaged state shown in FIG. 2 to the released state in FIG. 1. During the release operation, when oil is discharged from the hydraulic chamber 21a, pressing force acting on the engagement plate 4A from the oil bag 21 (a load in the engaging direction based on hydraulic pressure) is lost. Therefore, due to urging force from the return mechanism 7 (a load in the releasing direction), the engagement plate 4A moves in the releasing direction. Because of this, the frictional engagement surfaces of the first plate 4 and the frictional engagement surfaces of the second plate 5 are separated from each other, and the engagement device 1 is changed into the released state. During the release operation, the oil bag 21 contracts due to its own elastic force, and is compressed in the releasing direction by urging force from the return mechanism 7. When the state of the engagement device 1 is changed from the engaged state to the released state, the return mechanism 7 is able to force the oil bag 21 to return to its initial shape by pressing the oil bag 21 in the releasing direction through the engagement plate 4A. The urging force of the return spring 71 only needs to be sufficient to return the oil bag 21 into its initial shape.

As explained above, according to the first embodiment, the return mechanism 7 is able to move the engagement plate 4A in the releasing direction, and also force the oil bag 21 to return to its initial shape. Thus, the engagement device 1 is able to ensure that the engagement plate 4A serving as an engagement element is released.

Further, in the engagement device 1, the number of parts is smaller than that of a conventional fluid pressure actuator having a piston and a cylinder, thus achieving light weight. For example, when the engagement device 1 is mounted on a vehicle, weight of the transmission is reduced, and, drag torque generated during the release is reduced because of the return mechanism 7. As a result, fuel consumption is improved.

If the engagement device 1 does not include the return mechanism 7, the oil bag 21 will not return to the initial shape only with its own elastic force when oil is discharged (when released), because of deterioration of the material of the oil bag 21 with time. In this case, the engagement plate 4A might not return to the given position in the releasing direction, and drag torque could be generated during the release, which could deteriorate fuel consumption. Further, with generation of drag torque, friction heat is generated between the first plate 4 and the second plate 5, and such heat generation could reduce durability of the plates 4, 5 and the oil bag 21. In particular, because the engagement device 1 is a multiplate clutch, a stroke distance of the engagement element is long, and an expected distance of the oil bag 21 to return in the releasing direction using its own elastic force is long (in other words, deformation of the oil bag 21 is large). On the contrary, in the engagement device 1 according to the first embodiment, since the return mechanism 7 forces the engagement plate 4A and the oil bag 21 to return in the releasing direction, it is possible to ensure that the engagement elements are released. Because of this, drag torque is reduced, and fuel consumption is improved. Also, since drag torque generated during release is stabilized, vibration and noise are reduced. In addition, in the engagement device 1, sliding friction is reduced compared to a conventional structure in which a seal member such as an O ring is provided in a sliding part between a piston and a cylinder. Thus, responsiveness to oil discharge (decompression of hydraulic chamber 21a) is improved. According to the engagement device 1, a highly responsive release operation becomes possible.

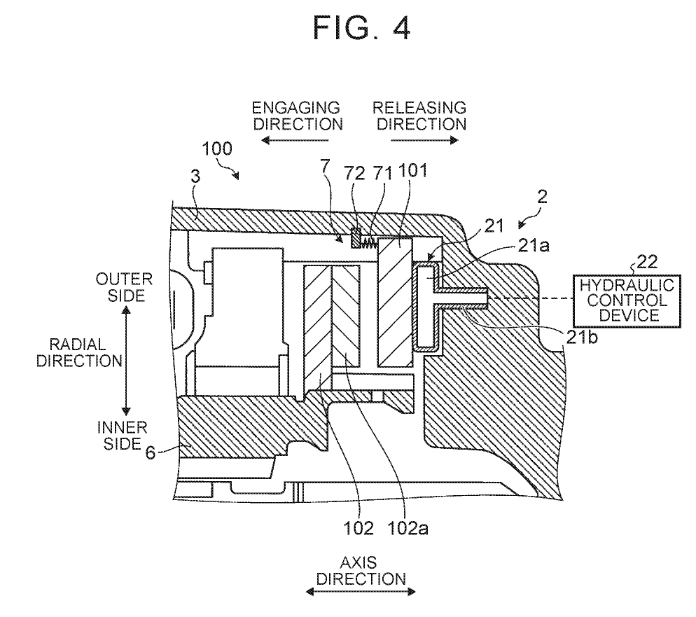

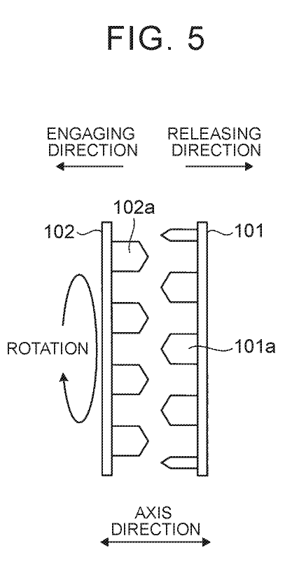

As a modification of the first embodiment, an engagement device 1 may be a meshing type engagement device 100 as shown in FIG. 4. An engagement device 100 according to the modification has a pair of gear engagement elements 101, 102. The first gear engagement element 101 is a fixed-side engagement element, which is made of an annular plate, and an outer circumferential part of the first gear engagement element 101 is spline-fitted to a case 3. The second gear engagement element 102 is a rotation-side engagement element, which is formed into an annular shape, and an inner circumferential part of the second gear engagement element 102 is spline-fitted to a rotating member 6. As shown in FIG. 5, the first gear engagement element 101 has a plurality of dog teeth 101a projecting from the annular plate in an engaging direction. The second gear engagement element 102 has a plurality of dog teeth 102a projecting from the annular plate in a releasing direction. Further, as shown in FIG. 4, a hydraulic actuator 2 is able to move the first gear engagement element 101 in the engaging direction and the releasing direction, and a return mechanism 7 moves the first gear engagement element 101 in the releasing direction. Meanwhile, the second gear engagement element 102 is fixed so as not to move in the axis direction.

When the engagement device 100 is engaged, oil (hydraulic pressure) is supplied to a hydraulic chamber 21a, and, once the oil bag 21 expands, the oil bag 21 presses a surface of the first gear engagement element 101 on the releasing direction side in the engaging direction. Then, the first gear engagement element 101 moves in the engaging direction, and the dog teeth 101a of the first gear engagement element 101 and the dog teeth 102a of the second gear engagement element 102 mesh each other, thereby turning the engagement device 100 into an engaged state (a meshed state).

When the engagement device 100 is released, oil is discharged from the hydraulic chamber 21a (hydraulic pressure is decreased), and then an oil bag 21 contracts due to its own elastic force. In addition, the return mechanism 7 moves the first gear engagement element 101 in the releasing direction, and also compresses the oil bag 21. Then, as the dog teeth 101a of the first gear engagement element 101 come off from the dog teeth 102a of the second gear engagement element 102, and meshing is thus released, thereby turning the engagement device 100 into a released state.

With the engagement device 100 according to the modification, the return mechanism 7 is able to return the first gear engagement element 101 in the releasing direction, and force the oil bag 21 to return into its initial shape. Therefore, the engagement device 100 is able to ensure that the meshed state is released.

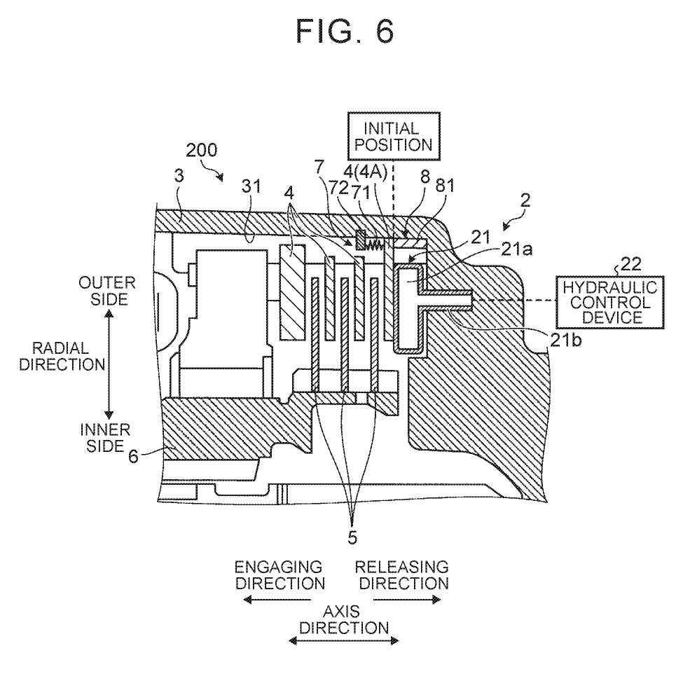

Next, an engagement device according to the second embodiment is explained with reference to FIG. 6. Unlike the first embodiment, the engagement device according to the second embodiment has a stopper structure 8 that restricts movements of an engagement plate 4A in a releasing direction at a given position. In the explanation of the second embodiment, explanation of structures similar to those of the first embodiment is omitted, and the same reference numerals are used.

As shown in FIG. 6, an engagement device 200 according to the second embodiment has the stopper structure 8 that stops the engagement plate 4A, which is moved by a return mechanism 7 in a releasing direction, at a given position (a given initial position). The stopper structure 8 has a projecting part 81 integrated with a case 3. In a part where the case 3 and the engagement plate 4A (the first plate 4) are spline-fitted to each other, the projecting part 81 is provided in a spline recessed part 31 of the case 3. In the example shown in FIG. 6, the projecting part 81 is provided on the opposite side of the return mechanism 7 across the engagement plate 4A and on a radially outer side of an oil bag 21, and projects in a radially inner side from a bottom part of the spline recessed part 31.

When the state of the engagement device 200 is switched from an engaged state to a released state, the return mechanism 7 is able to force the engagement plate 4A to return to its initial position. The initial position means a given position where the engagement plate 4A is in contact with the oil bag 21 in the initial shape in a state where the engagement plate 4A is not pressed by hydraulic pressure inside the oil bag 21. Further, since the engagement plate 4A and the case 3 are brought into contact with each other by the stopper structure 8, the engagement plate 4A stops at the initial position.

According to the second embodiment, the return mechanism 7 and the stopper structure 8 are able to ensure that the engagement plate 4A is returned to the initial position at the time of release. Thus, drag torque during release is stabilized, thereby reducing vibration and noise such as rattling.

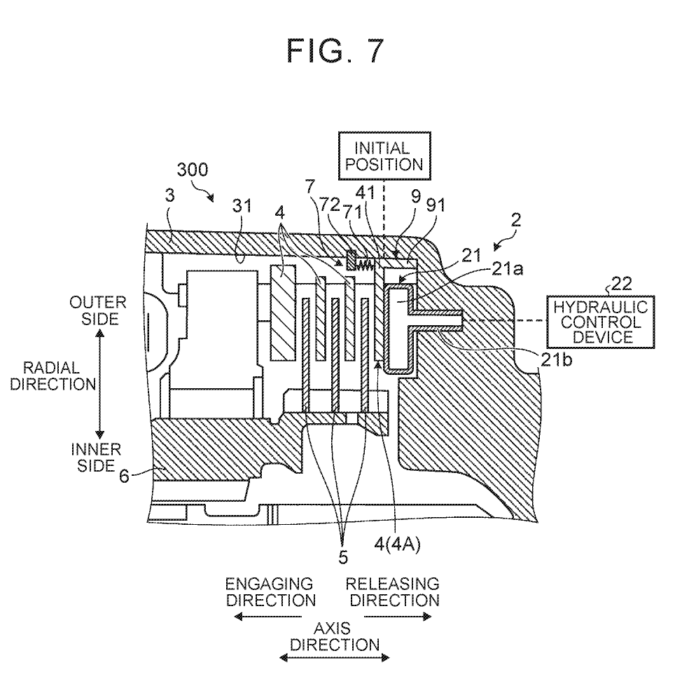

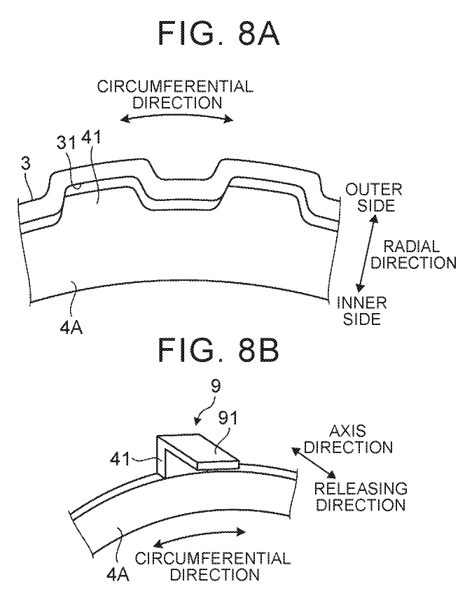

As a modification of the second embodiment, an engagement device 300 may be provided, which has a stopper structure 9 integrally structured with a first plate 4 as shown in FIG. 7, FIG. 8A and FIG. 8B. In the explanation of this modification, explanation of structures similar to those of the second embodiment is omitted, and the same reference numerals are used.

As shown in FIG. 7, FIG. 8A and FIG. 8B, in the engagement device 300 according to the modification, the stopper structure 9 has a projecting part 91 that is structured integrally with a spline projecting part 41 of an engagement plate 4A. The projecting part 91 projects in the releasing direction from a distal end (a radially outer part) of the spline projecting part 41. To be more specific, as shown in FIG. 8A, a plurality of the spline projecting parts 41 are provided in an outer circumferential part of the engagement plate 4A, and spline-fitted to the spline recessed parts 31 of the case 3. Further, the plurality of spline recessed parts 31 are provided in a circumferential direction. As shown in FIG. 8B, the projecting part 91 is formed into a plate shape that projects from the spline projecting part 41 in the releasing direction. For example, the projecting part 91 may be formed of a structure in which a distal end (a radially outer part) of the spline projecting part 41 is bent. When the engagement plate 4A moves in the releasing direction, the bent projecting parts 91 come into contact with the case 3, thereby stopping the engagement plate 4A at the initial position.

With the engagement device 300 according to the modification, the return mechanism 7 and the stopper structure 9 are able to ensure that the engagement plate 4A is returned to the initial position when released. Thus, drag toque during release is stabilized, thereby reducing vibration and noise such as rattling.

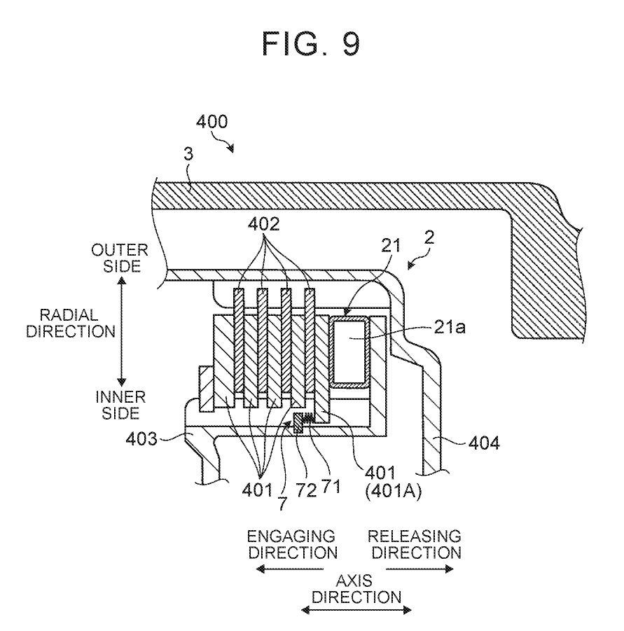

As a modification of the foregoing engagement devices 1, 100, 200, 300, an engagement device 400 may be provided, which is a friction-type multiplate clutch in which both engagement elements 401, 402 are able to rotate as shown in FIG. 9. Further, a hydraulic actuator 2 may press an engagement element whose inner circumferential part is spline-fitted.

In this modification, first engagement elements 401 are annular clutch plates whose inner circumferential parts are spline-fitted to a clutch hub 403, and second engagement elements 402 are annular clutch plates (clutch discs) whose outer circumferential parts are spline-fitted to a clutch cover 404. As shown in FIG. 9, in the engagement device 400 having the engagement elements 401, 402, an oil bag 21 is arranged inside the clutch cover 404. The clutch cover 404 is housed in a case 3, and is structured so as to rotate integrally with a rotating member of a transmission.

The hydraulic actuator 2 provided in the engagement device 400 has the oil bag 21 provided between the first engagement element 401 and the clutch hub 403. The oil bag 21 is connected with a hydraulic control device 22 (not shown) so that oil is able to pass.

In a return mechanism 7, a snap ring 72 is attached to a spline recessed part of the clutch hub 403 in a part where the first engagement element 401 and the clutch hub 403 are spline-fitted to each other. Among the first engagement elements 401, the engagement plate 401A arranged on the most releasing direction side (a position close to the oil bag 21) is an engagement element that is in contact with the oil bag 21. One end of the return spring 71 is in contact with a surface of the engagement plate 401A on the engagement side (a spline projecting part).

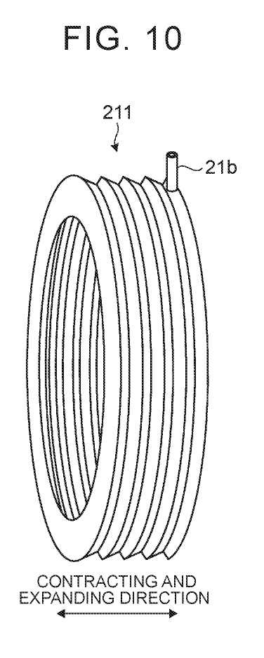

The oil bag 21 is not limited to the foregoing structure having a quadrangular sectional shape, and may be an oil bag 211 having a bellows structure as shown in FIG. 10. The oil bag 211 is an elastic container deformed by the bellows structure in the engaging direction and the releasing direction (contracting and expanding direction). A material of the oil bag 211 is no limited elastic member. The material of the oil bag 211 may be elastomer, a resin material, or metal. When hydraulic pressure inside the oil bag 211 is decreased, the oil bag 211 is able to contract in the releasing direction.

Further, although not shown, as a modification of the oil bag 21 made of an annular tube, a plurality of oil bags, each of which is made of a balloon, may be provided in a circumferential direction of the engagement plate 4A.

What is claimed is:

1. An engagement device comprising:
a fluid pressure actuator provided with an expandable container,
the expandable container configured to
i) expand in an engaging direction by fluid supplied into the expandable container,
ii) contract in a releasing direction by the fluid discharged from inside of the expandable container;
an engagement plate being an annular engagement plate,
the engagement plate configured to be moved to the engaging direction and the releasing direction by the expandable container, a surface of the engagement plate located on the releasing direction side being an engagement element that is to be contact with the expandable container; and
a return mechanism configured to urge the engagement plate in the releasing direction, the return mechanism being configured to move the engagement plate to the releasing direction, the return mechanism being configured to press the expandable container via the engagement plate.

2. The engagement device according to claim 1, further comprising a stopper configured to restrict a movement of the engagement plate in the releasing direction at a given position, wherein
the expandable container is provided between a case that houses a transmission and the engagement plate,
when the fluid is discharged from inside of the expandable container, the stopper is configured to bring the engagement plate and the case into contact with each other, and the engagement plate stops at the given position.

3. The engagement device according to claim 2, wherein
the case includes a spline recessed part that is spline-fitted to an outer circumferential part of the engagement plate,
the spline recessed part is provided with a projecting part as the stopper, and
the engagement plate is configured to stop at the given position as the outer circumferential part of the engagement plate comes into contact with the projecting part.

4. The engagement device according to claim 2, wherein
the outer circumferential part of the engagement plate is provided with a spline projecting part that is spline-fitted to the case,
the spline projecting part is provided with a projecting part projecting in the releasing direction, and
the engagement plate is configured to stop at the given position when the projecting part serving as the stopper comes into contact with the case.

5. An engagement device comprising:
a first plate being an annular engagement plate;
a second plate being an annular engagement plate;
a fluid pressure actuator provided with an expandable container;
the expandable container configured to
i) expand by fluid supplied into the expandable container such that the first plate and the second plate engage each other,
ii) contract by the fluid discharged from inside of the expandable container such that the first plate and the second plate are released each other,
iii) contact with a surface of the first plate opposite to a surface that contacts with the second plate; and
a return mechanism configured to urge the first plate such that the return mechanism presses the expandable container via the first plate thereby the first plate and the second plate are released each other.
